(19) United States
(12) Patent Application Publication
(10) Pub. No.: US 2022/0366217 A1
(43) Pub. Date: Nov. 17, 2022

(54) METHOD AND DEVICE OF COMPUTING LAYOUT SELECTION FOR EFFICIENT DNN INFERENCE

(71) Applicant: SAMSUNG ELECTRONICS CO., LTD., Suwon-sI (KR)

(72) Inventors: Briraj SINGH, Bengaluru (IN); Amogha UDUPA SHANKARANARAYANA GOPAL, Bengaluru (IN); Aniket DWIVEDI, Bengaluru (IN); Bharat MUDRAGADA, Bengaluru (IN); Alladi Ashok Kumar SENAPATI, Bengaluru (IN); Suhas Parlathaya KUDRAL, Bengaluru (IN); Arun ABRAHAM, Bengaluru (IN); Praveen Doreswamy NAIDU, Bengaluru (IN)

(21) Appl. No.: 17/864,596

(22) Filed: Jul. 14, 2022

Related U.S. Application Data
(63) Continuation of application No. PCT/KR2021/020175, filed on Dec. 29, 2021.

(30) Foreign Application Priority Data
Dec. 29, 2020 (IN) 202041056865
Dec. 27, 2021 (IN) 2020 41056865

(51) Int. Cl. G06N 3/04

(52) U.S. Cl. CPC G06N 3/04

(57) ABSTRACT

Embodiments herein provide a method and system for network and hardware aware computing layout selection for efficient Deep Neural Network (DNN) Inference. The method comprises: receiving, by the electronic device, a DNN model to be executed, wherein the DNN model is associated with a task; dividing the DNN model into a plurality of sub-graphs, wherein each sub-graph is to be processed individually; identifying a computing unit from a plurality of computing units for execution of each sub-graph based on a complexity score; and determining a computing layout from a plurality of computing layouts for each identified computing unit, wherein the sub-graph is executed on the identified computing unit through the determined computing layout.

### CROSS-REFERENCE TO RELATED APPLICATIONS

This application is a continuation of International Application No. PCT/KR2021/020175 designating the United States, filed on Dec. 29, 2021, in the Korean Intellectual Property Receiving Office and claiming priority to Indian Provisional Application No. 202041056865, filed on Dec. 29, 2020, in the Indian Patent Office, and to Indian Complete Application No. 202041056865, filed on Dec. 27, 2021, in the Indian Patent Office, the disclosures of all of which are incorporated by reference herein in their entireties.

### BACKGROUND

### Field

The disclosure relates to Deep Neural Network (DNN) Inference and, for example, to a method and device of network and hardware aware computing layout selection for efficient DNN Inference.

### Description of Related Art

In general, latest mobile hardware are powered with target processors (Central Processing Unit (CPU), Graphic Processing Unit (GPUs), Digital Signal Processor (DSP), and Network Processor Unit (NPU) for a DNN inference. The DNN inference may refer, for example, to a process of using a trained DNN model to make predictions against previously unseen data.

Each target processor for execution of the DNN model has a choice for computing layout selection, e.g. Buffer, Texture, OpenGL, Vulkan etc. for the GPU. Each computing layout has its own advantage based on a configuration of an electronic device on which the computing layout is executed. For example, the buffer computing layout performs better for lower resolution DNN model like Camera Shot Suggestion, but the texture computing layout performs better for high resolution input DNN model e.g. Night-Mode, Deblur. The above example is based on only DNN model input resolution. There are several other parameters which may impact performance of use-case on various mobile hardware.

Currently most, if not all, Artificial Intelligence (AI) use-cases are deployed with static computing layout acceleration, which limit from attaining the best user experience. However, none of the method for layout selection for DNN model execution takes the DNN model parameters, an electronic device capability on which the DNN Model is executed, and a state of the electronic device into consideration.

Thus, it is desired to address the above mentioned disadvantages or other shortcomings or at least provide a useful alternative.

### SUMMARY

Embodiments of the disclosure provide a method and system of network and hardware aware computing layout selection for efficient DNN Inference.

Embodiments of the disclosure provide a method and system of network and hardware aware computing layout selection for efficient DNN Inference. Efficient DNN inference results in faster execution (Reduced inference time) of DNN as the best performing computing layout is selected. Further, for models where different input shapes (Selfie) are passed or tiling based (Night mode) use cases where during real-time execution input shapes are decided, setting static computing layout have inferior performance after certain point. For these such type of use-cases selecting computing layout dynamically always give best performance.

These and other aspects of various example embodiments herein will be better appreciated and understood when considered in conjunction with the following description and the accompanying drawings. It should be understood, however, that the following descriptions, while indicating various example embodiments and numerous specific details thereof, are given by way of illustration and not of limitation. Many changes and modifications may be made within the scope of the disclosure herein without departing from the spirit thereof, and the various embodiments disclosed herein include all such modifications.

### BRIEF DESCRIPTION OF THE DRAWINGS

Various example embodiments of the disclosure are illustrated in the accompanying drawings, throughout which like reference letters indicate corresponding parts in the various figures. The above and other aspects, features and advantages of certain embodiments of the present disclosure will be more apparent from the following detailed description, in which:

FIG. 1 is a block diagram illustrating an example configuration of an electronic device for computing layout selection for efficient DNN Inference, according to various embodiments;

FIG. 2 is a block diagram illustrating the device status analyzer for obtaining device capabilities, according to various embodiments;

FIG. 3 is a diagram illustrating an example complexity analyzer for determining complexity of each sub-graph and assigning the complexity score to each sub-graph, according to various embodiments;

FIG. 4 is a diagram illustrating an example sub-graph splitter \for splitting the task into plurality of sub-graph for execution, according to various embodiments;

FIG. 5 is a diagram, illustrating an example AI model specific to selection of computing layout for efficient DNN inference according to various embodiments;

FIG. 6A is a diagram illustrating an example of selecting computing unit for efficient DNN inference, according to various embodiments;

FIG. 6B is diagram illustrating an example of selecting computing unit for efficient DNN inference, according to various embodiments;

FIG. 7 is a diagram, illustrating an example of selection of computing unit, according to various embodiments;

FIG. 8 is a flowchart illustrating example selection of the computing layout for best performance of the selected computing unit GPU, according to various embodiments;

FIG. 9 is a diagram, illustrating an example pipeline architecture for selection of the computing layout, according to various embodiments;

FIG. 10 is a diagram, illustrating an example dynamic computing layout of the DNN inference, according to various embodiments; and

FIG. 11 is a diagram, illustrating example selection of computing layout, according to various embodiments.

### DETAILED DESCRIPTION

The various example embodiments herein and the various features and advantageous details thereof are explained in greater detail below with reference to the accompanying drawings and detailed in the following description. Descriptions of well-known components and processing techniques may be omitted so as to not unnecessarily obscure the embodiments herein. The various example embodiments described herein are not necessarily mutually exclusive, as various embodiments may be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the disclosure.

As is traditional in the field, various example embodiments may be described and illustrated in terms of blocks which carry out a described function or functions. These blocks, which may be referred to herein as managers, units, modules, hardware components or the like, may be physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the example embodiments may be physically separated into two or more interacting and discrete blocks without departing from the scope of the disclosure. The blocks of the various example embodiments may be physically combined into more complex blocks without departing from the scope of the disclosure.

Accordingly the examples herein provide a method and system of network and hardware aware computing layout selection for efficient Deep Neural Network (DNN) Inference which will result in faster execution (e.g., reduced inference time) of DNN as best performing computing layout is selected by probabilistic distribution algorithm. Further, for models where different input shapes (e.g., selfie) are passed or tiling based (e.g., night mode) use cases where during real-time execution input shapes are decided, setting static computing layout will have inferior performance after certain point. For these types of use-cases selecting computing layout dynamically will give best performance.

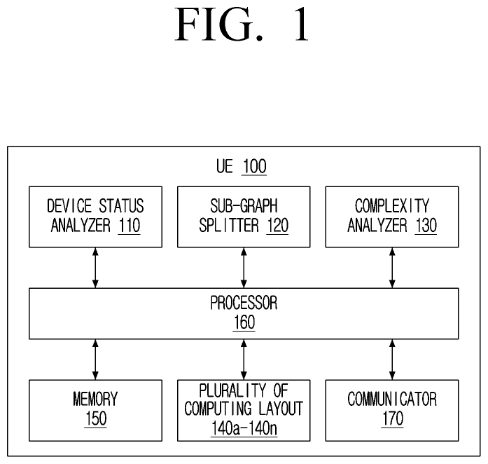

Referring now to the drawings and more particularly to FIGS. 1 through 11, where similar reference characters denote corresponding features throughout the figures, there are shown various example embodiments.

A method according to various example embodiments may provide selections of specific computing layout of a target processor based upon probabilistic distribution or classification algorithm from a combination of parameters which are network parameters (e.g., input shapes, types of layers, MACCs, FLOPs) and hardware parameters and not directly setting the computing layout based upon type of hardware as this not always gives the best performance for DNN Inference.

FIG. 1 is a block diagram illustrating an example configuration of an electronic device 100 for computing layout selection for efficient DNN Inference, according to various example embodiments.

The electronic device (100) may include, for example, but is not limited to, a mobile device, a cellular phone, a smartphone, a Personal Digital Assistant (PDA), a tablet computer, a laptop computer, an Internet of things (IoT) device, an Artificial Intelligent (AI) device or the like.

In an embodiment, the electronic device (100) includes a device status analyzer (e.g., including various processing circuitry and/or executable program instructions) (110), a sub-graph splitter (e.g., including various processing circuitry and/or executable program instructions) (120), a complexity analyzer (e.g., including various processing circuitry and/or executable program instructions) (130), a plurality of computing layouts (e.g., including various processing circuitry and/or executable program instructions) (140a-140n), a memory (150), a processor (e.g., including processing circuitry) (160), and a communicator (e.g., including communication circuitry) (170).

In an embodiment, the proposed method and the electronic device (100) may determine a best computing layout from the plurality of computing layouts (140a-140n) for execution of a task on the electronic device (100) using the above described units. In an embodiment, the task may include a Depp Neural Network (DNN) for execution of the task. In an embodiment, the task may comprise any AI neural network.

The device status analyzer (110) may include various processing circuitry and/or executable program instructions and may determine information about the device capabilities, such as number of CPU cores, GPU cores, available frequency for computing units and memory transfer cost between different compute units.

During a use case, the device status analyzer (110) may collect a current load on different computing units. In an embodiment, the device status analyzer (110) may determine the current thermal condition, and sends a heuristic score for each compute unit, such as how ideal it is to run a task on the compute unit.

In an embodiment, the DNN model to be executed comprises a plurality of graphs which are further split into sub-graphs using the sub-graph splitter (120). In an embodiment the DNN model may be split into multiple sub-graphs based on the support of operations available in each computing unit and dependency of operation on each other.

In an embodiment, operations supported on similar computing units are grouped together as a sub-graph, such that the sub-graph is assigned a computing unit from the supported computing units that provides best performance.

After the sub-graphs are obtained, the complexity analyzer (130), may determine a complexity score for each sub-graph obtained by the sub-graph splitter (120). Determination of the complexity score for each sub-graph is explained in greater detail below.

The complexity score for each sub-graph, available computing unit and dependencies between different sub-graphs for an operation is fed as an input to an Artificial Intelligence (AI) model specific to determination of different computing unit for execution of the sub-graphs.

The AI model provides a specific computing each for each sub-graphs, wherein the computing units may include, for example, and without limitation, the GPU, the CPU, the NPU and the like.

Further, the processor (160) may include various processing circuitry and determines the computing layout from the plurality of computing layouts (140a-140n) for execution of each sub-graph.

The memory (150) stores instructions to be executed by the processor (160) for determining the computing layout for efficient DNN inference. The memory (150) storage elements may include magnetic hard discs, optical discs, floppy discs, flash memories, or forms of electrically programmable memories (EPROM) or electrically erasable and programmable (EEPROM) memories, but is not limited thereto.

In addition, the memory (150) may, in some examples, be considered a non-transitory storage medium. The “non-transitory” storage medium is not embodied in a carrier wave or a propagated signal. However, the term “non-transitory” should not be interpreted that the memory (150) is non-movable. In some examples, the memory (150) can be configured to store larger amounts of information than the memory. In certain examples, a non-transitory storage medium may store data that can, over time, change (e.g., in Random Access Memory (RAM) or cache). The memory (150) can be an internal storage or it can be an external storage unit of the electronic device (100), a cloud storage, or any other type of external storage.

In an embodiment, the processor (160) may communicate with the device status analyzer (110), the sub-graph splitter (120), the complexity analyzer (130), the plurality of computing layouts (140a-140n), the memory (150), and the communicator (170). The processor (160) is configured to execute instructions stored in the memory (150) for generating the dense depth. The processor (150) may include one or a plurality of processors, may include, for example, and without limitation, a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

In an embodiment, the communicator (170) may include various communication circuitry and is configured for communicating internally between internal hardware components and with external devices via one or more networks. The communicator (170) may include an electronic circuit specific to a standard that enables wired or wireless communication.

Although the FIG. 1 illustrates various hardware components of the electronic device (100), it is to be understood that the various example embodiments are not limited thereto. In various embodiments, the electronic device (100), the may include less or more number of components. Further, the labels or names of the components are used only for illustrative purpose and does not limit the scope of the disclosure. One or more components can be combined together to perform same or substantially similar function to determining the computing layout for efficient DNN inference.

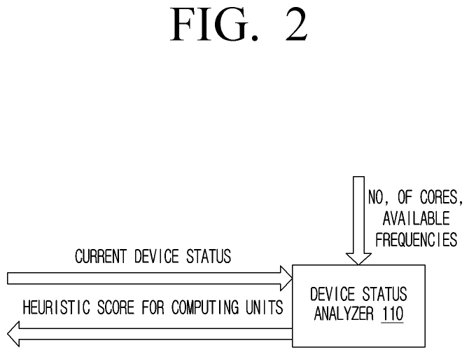

FIG. 2 is a diagram illustrating the device status analyzer (110) for obtaining device capabilities, according to various embodiments.

As illustrated in FIG. 2, the device status analyzer (110) takes a current status of the electronic device (100) and information about the processor (160) (e.g., no. of cores, available frequencies, etc.) as input and provides a Heuristic score for the plurality of computing units (140a-140n) as an output.

In an embodiment, during the boot-up of the electronic device (100), device status analyzer (110) may receive the device capabilities, such as, for example, and without limitation, number of CPU cores, GPU cores, available frequency for the plurality of computing units (140a-140n), memory transfer cost between compute units, etc.

In an embodiment, during a use case, the device status analyzer (110) collects a current load on the plurality of computing units (140a-140n). The device status analyzer (110) may also consider the current thermal condition, and determined the heuristic score for each compute unit from the plurality of computing units (140a-140n), wherein the heuristic score may determine how ideal it is to run a desired task on the compute unit.

Considering the device status for determining the heuristic score helps in obtaining a best compute units from the plurality of computing units (140a-140n) which are idle and can be assigned the desired tasks to avoid increase in inference timings.

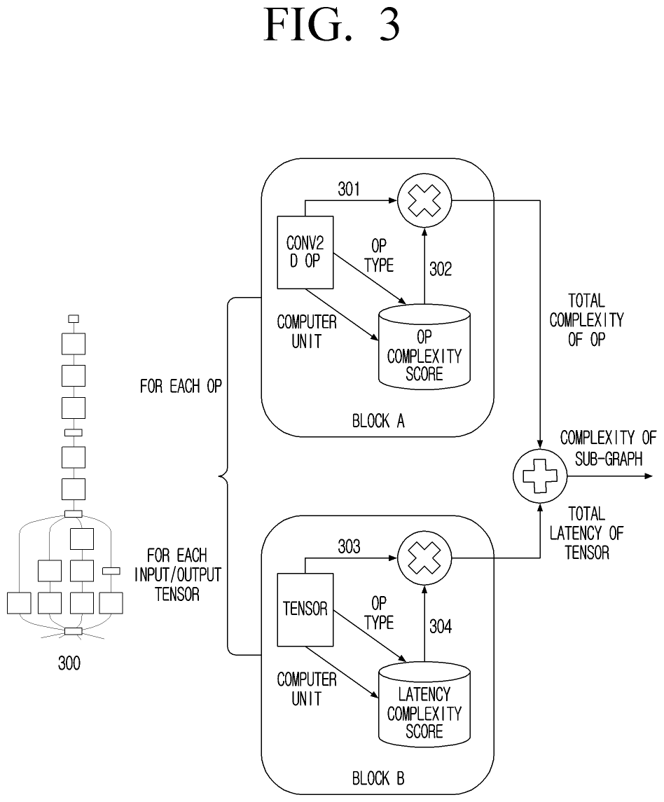

FIG. 3 is a diagram illustrating an example complexity analyzer (130) for determining complexity of each sub-graph and assigning the complexity score to each sub-graph, according to various embodiments.

In an embodiment, the execution time of each sub-graph may be calculated by the complexity analyzer (130).

The execution of the sub-graphs depends on the execution time of all the operations in the sub-graph and a latency of moving input/output tensors to and from the compute unit. The Execution time of each operation depends on a type of the operation (e.g., convolution may require more time than addition), a size of the input to the sub-graph (e.g., where input size increases then no of operations increases there by increasing execution time) and the compute unit (e.g., GPU may execute some operations faster than CPU).

The complexity score of each sub-graph is determined as shown in FIG. 3 of the DNN model (300). As illustrated in FIG. 3, block A determines a total complexity of the operation and block B determines the total latency of the tensor. In an embodiment, the total complexity of the operation may be constant and may be learned in a new electronic device.

The block A, takes the number of input elements (301) and a complexity per element from an operation complexity score (302) as input. The total complexity of the operation is given by equation 1.

T(op)=(No of input elements)*T(complexity of op per element in compute unit) Equation 1

The block B, takes the number of input elements (303) and a complexity per element from a latency complexity score (304) as input. The total latency of the tensor is calculated by multiplying (303) and (304).

In an embodiment, a software representation of the neural layer is called as tensor

The complexity score of the sub-graph is determined by equation 2.

T(subgraph)=ΣT(OP)+ΣT(Input Latency)+ΣT(Output Latency) Equation 2

Consider an example sub-graph with inputs as 1, 224, 224, 3 and outputs as 1, 112, 112, 64. The first operation is a 2 dimensional convolution (Conv2D) with filter (32*3*3*3) bias (32).

In case the computing unit is the CPU, then

For first OP: Inputs: (1, 224, 224, 3), (32, 3, 3, 3), (32)

Complexity: C_{conv/CPU}*π(input shapes)=C1

For second OP:

Inputs: (1, 112, 112, 3), (1, 3, 3, 32), (32)

Complexity: C_{DwConv/CPU}*π(input shapes)=C2

For third OP:

Inputs: (1, 112, 112, 3), (64, 1, 1, 32), (64)

Complexity: C_{Cconv}*π(input shapes)=C3

Latency:

L(tensor)CPU=0

(execution start and end from CPU)

OL CPU=0

TC CPU=C1+C2+C3+OL CPU,

Complexity of OP per element for given Compute Unit, Lcompute unit is Latency of moving data per element for given Compute Unit, OLcompute unit is Overall Latency time for given Compute Unit, TCcompute unit is the Total complexity for given Compute Unit.

In an embodiment, when the computing unit GPU:

For first OP:

Inputs: (1, 224, 224, 3), (32, 3, 3, 3), (32)

Complexity: C_{conv/CPU}*π(input shapes)=C1

For second OP:

Inputs: (1, 112, 112, 3), (1, 3, 3, 32), (32)

Complexity: C_{DwConv/CPU}*π(input shapes)=C2

For third OP:

Inputs: (1, 112, 112, 3), (64, 1, 1, 32), (64)

Complexity: C_{Cconv}*π(input shapes)=C3

Latency: L(tensor)GPU=LGPU*π(input/output shapes)

OL GPU=L (tensor)GPU

TC GPU=C1+C2+C3+OL GPU

Thus, if TC GPU<TC CPU then subgraph is marked to run on GPU, else sub-graph is marked to run on CPU.

As seen in the above example, the computing unit is decided.

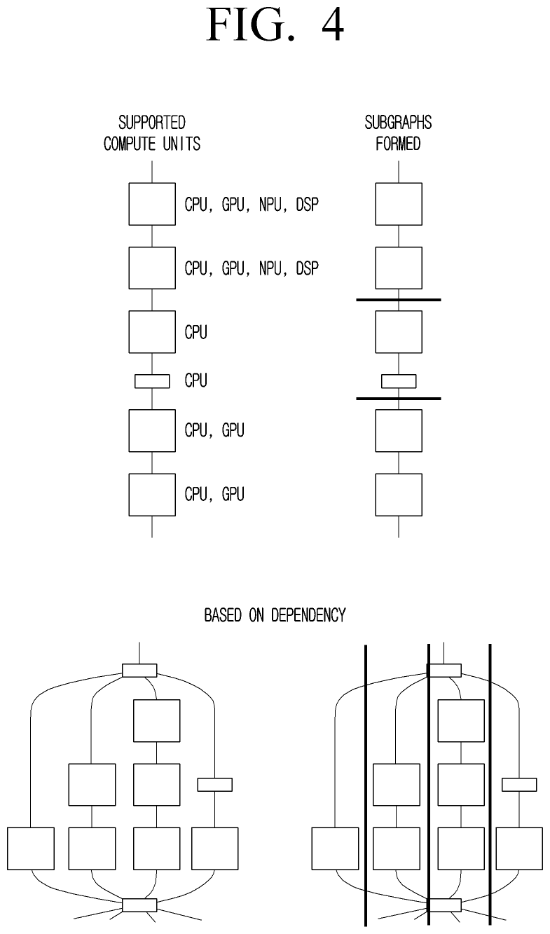

FIG. 4 is a diagram illustrating an example of the sub-graph splitter (120) for splitting the task into plurality of sub-graph for execution, according to various embodiments.

The inference model is split into multiple sub-graph based on the support of the operations in available compute units and dependency of the operations with each other

All the operations supported on similar compute units are grouped together as a sub-graph. The subgraph can be assigned a compute unit from the supported compute units that provides best performance.

By considering the dependency of operations with each other, independent sub-graphs may be formed such that they can be executed parallel in different compute units based on the decision of the AI model.

The images on the right of FIG. 4 are examples illustrating graph formation based on supported operation and dependency on each other, according to an embodiment as disclosed herein.

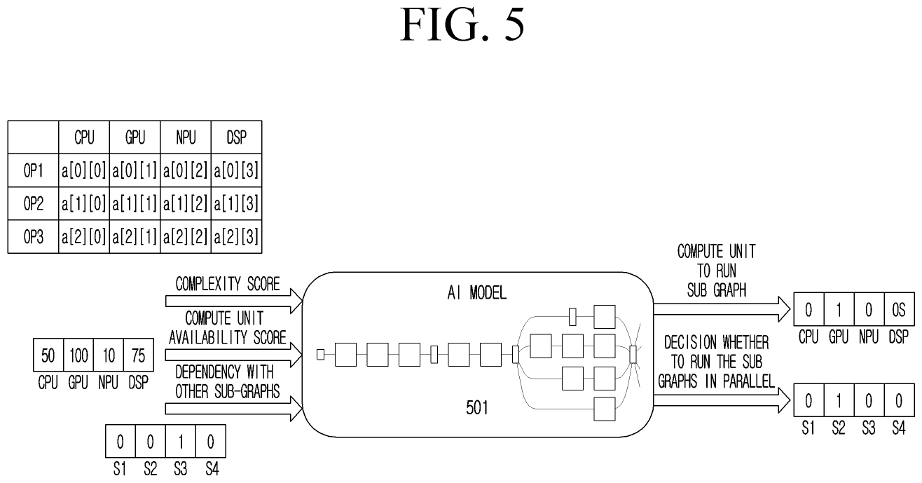

FIG. 5 is a diagram, illustrating an example of the AI model specific to selection of computing layout for efficient DNN inference according to various embodiments.

As illustrated in FIG. 5, the AI model (501) takes the complexity score of the sub-graph, the compute unit availability and dependency of the sub-graph for whom the computing unit is to be determined with other sub-graphs as input and provides the computing unit for efficient execution of the sub-graph and a decision whether to execute the sub-graph with other sub-graphs in parallel.

The AI Model (501) is trained over a period of time with different models and load conditions to take decisions that provide better performance. An on-device learning may be applied to personalize the model according to the type of device and device conditions.

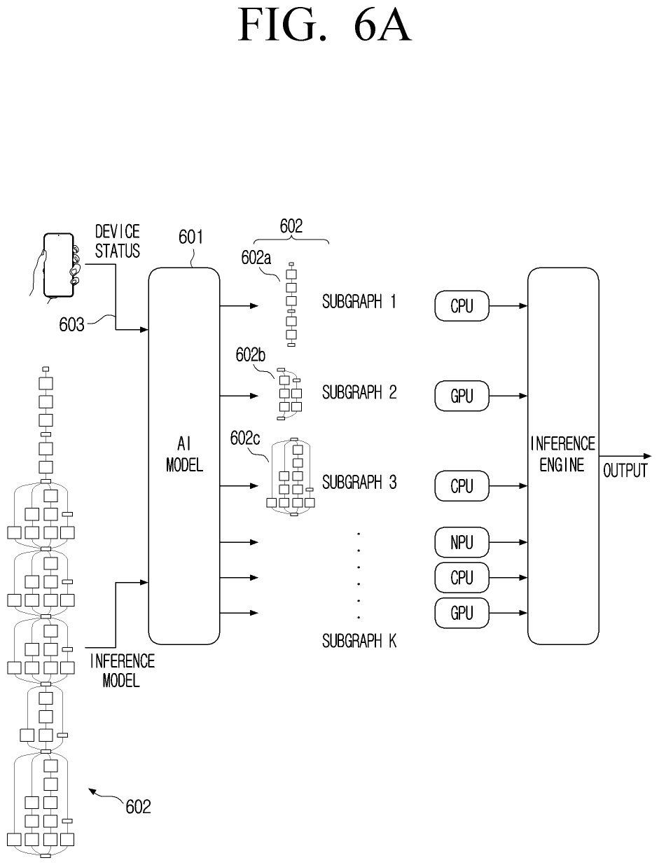

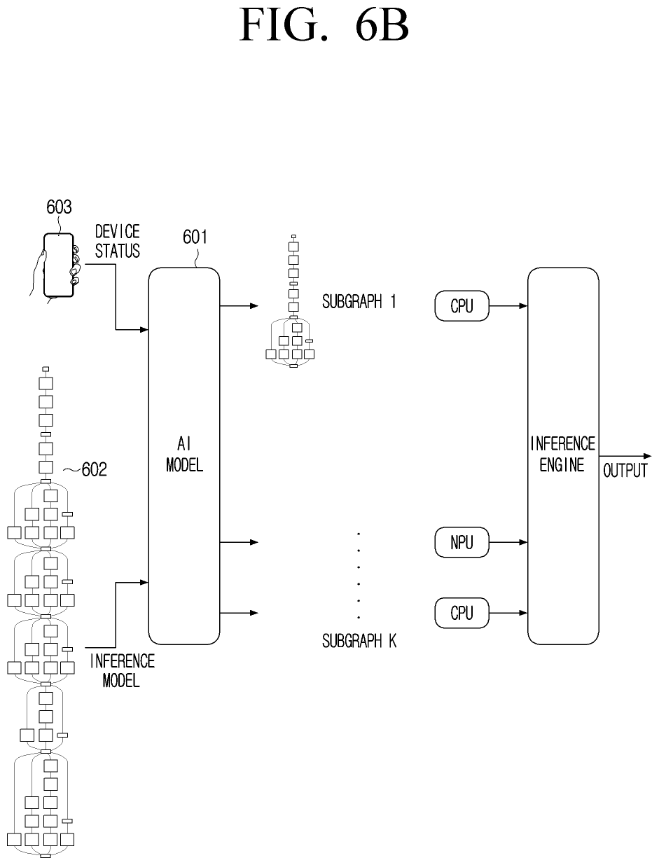

FIG. 6A is a diagram illustrating an example scenario of selecting computing unit for efficient DNN inference, according to various embodiments.

As seen in FIG. 6A, 601 is the AI model, 602 indicates the plurality of sub-graphs (602a, 602b, 602c, etc.) of the DNN model (inference model), 603 is the device status. In an embodiment, the complexity score of the sub-graph, the compute unit availability and dependency of the sub-graph for whom the computing unit is to be determined with other sub-graphs are also provided as input.

As seen, the AI model (601) assigns computing unit to different sub-graphs 602. In the illustrated scenario, all the compute units are free to execute operations.

The AI model (601) detects that a first sub graph (602a) provides better performance on CPU with respect to other compute units, so it is marked to run on CPU.

A second sub-graph (602b) provides better performance on GPU and sum of execution time in GPU combined with latency time of copying inputs and outputs to and from GPU is less than execution time in all other compute units, so it is marked to run on GPU.

A third sub-graph (602c) is similar to first sub-graph and provides better performance in CPU with respect to other compute units, so it is marked to run on CPU.

Similarly, the rest of the sub-graphs are assigned compute units in which they provide better performance

FIG. 6B is a diagram illustrating an example scenario of selecting computing unit for efficient DNN inference, according to various embodiments.

As seen in FIG. 6b, (601) is the AI model, (602) indicates the plurality of sub-graphs of the DNN model (inference model), (603) is the device status. In another embodiment, the complexity score of the sub-graph, the compute unit availability and dependency of the sub-graph for whom the computing unit is to be determined with other sub-graphs are also provided as input.

As seen, the AI model (601) assigns computing unit to different sub-graphs. In the current scenario, one or more compute units are busy with other tasks.

In the current scenario, the AI model (601) detects that the GPU is busy with other tasks and will take longer time to execute model operations.

Further, when comparing with other compute units, the second subgraph (602b) executes faster on CPU. Hence instead of assigning CPU to three different sub-graphs, the sub-graph splitter (120) provides only a single sub-graph in place of three sub-graphs as seen in above scenario and assign the CPU to the single sub-graph.

Similarly the rest of the sub-graphs are assigned compute units in which they provide better performance under current circumstances.

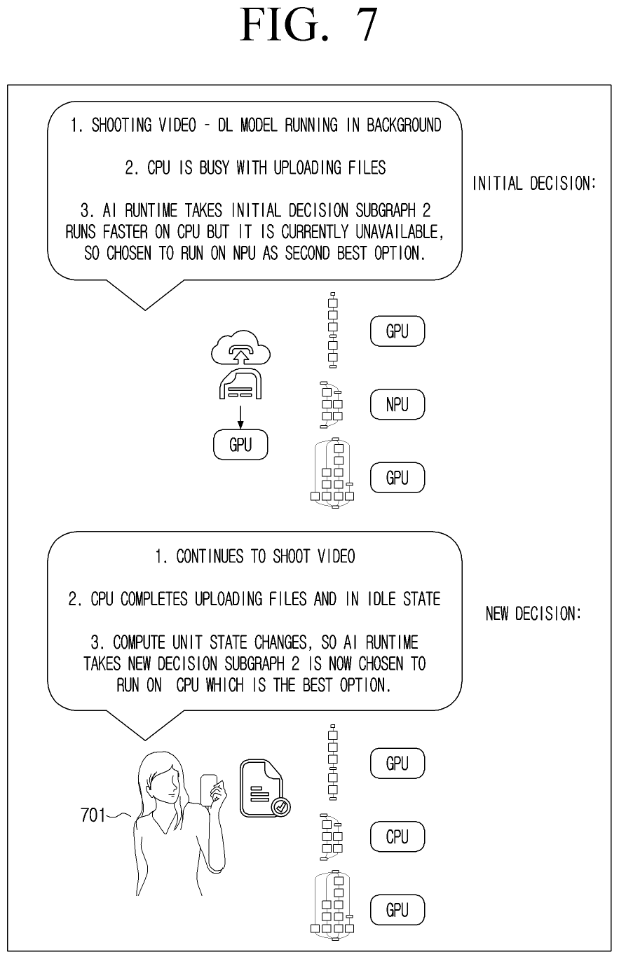

FIG. 7 is a diagram, illustrating an example scenario of selection of computing unit, according to various embodiments.

As seen in FIG. 7, a user (701), is shooting a video. In an embodiment, the CPU is busy with uploading files. The AI model (601) provides an initial decision, wherein a sub-graph 2 runs faster on CPU but it is currently unavailable, so the AI model (601) assigns the sub-graph 2 to the NPU as second best option.

Over a period of time, while the user (701) is till shooting the video, the CPU completes uploading files and is in idle state now. Now as the state of the CPU is changed, the AI model (601) takes new decision, wherein the sub-graph 2 is now chosen to run on the CPU which is the best option.

Thus, as seen above, the AI model (601) selects the best possible computing unit for execution of sub-graphs.

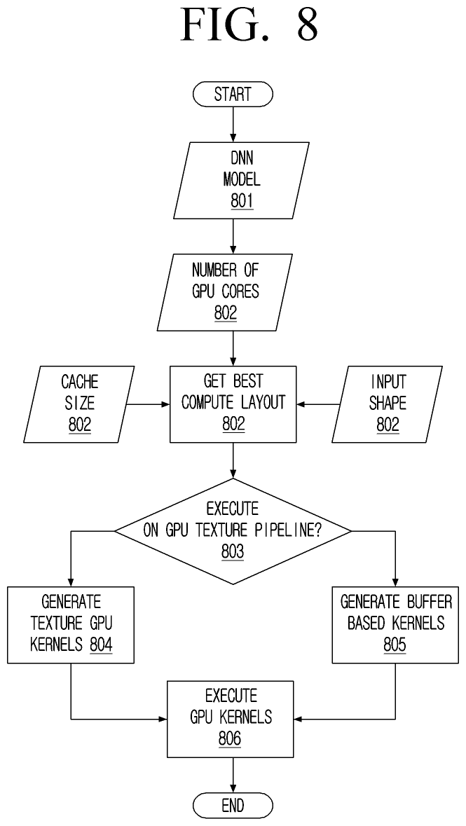

FIG. 8 is a flowchart illustrating example selection of the computing layout for best performance of the selected computing unit GPU, according to various embodiments.

The existing art does not disclose any to effectively use a hardware texture pipeline on various products with different neural network and different parameters.

However, embodiments of the disclosure provide selection of computing layout (hardware texture pipeline) for efficient execution using the computing unit.

As illustrated in FIG. 8, at 801, the execution of the sub-graph using the selected computing unit (GPU) is requested. At 802, a plurality of input parameters (e.g., number of GPU cores) are provided to an AI Model (800) specific to layout selection. The plurality of input parameters may include, for example, and without limitation, a cache size of the GPU, a number of GPU cores, and the DNN parameters. In an embodiment, the DNN parameters may include, for example, and without limitation, an input dimensions, a weight dimensions, an output dimensions, linear parameters and geometric parameters.

At 803, the AI model (803) determines, whether the sub-graph is to be executed on the GPU texture pipeline. In an embodiment, the GPU provides 2 ways to store data, one is a buffer type and the other is image type. So on modern GPU's the data pipeline for both memory types take a different path. Some GPU's provide multiple levels of cache for each of the pipelines.

At 804, the texture based GPU kernels are generated. At 805, buffer based GPU kernels are generated. At 806, the sub-graph is executed on the texture based GPU kernels. In an embodiment, the method comprises querying the electronic device (100) for the capabilities of the GPU and how much cache is provided for each of data pipelines. On most GPU's reading from texture is faster and writing to buffer is faster.

Thus, as seen above, the best computing layout is selected for execution of the sub-graph using the selected computed unit.

Table 1 below, illustrates performance of computing layouts of GPU on different inputs for a base resnet-50 architecture model, according to the embodiments as disclosed herein.

TABLE 1

| | | |
|---|---|---|
| | Time required for | Time required for |
| | computing layout 1 | computing layout 1 |
| Input | (Buffer) | (Image) |

| | | | | |
|---|---|---|---|---|
| 300 300 3 | 95 | ms | 104 | ms |
| 400 400 3 | 136 | ms | 141 | ms |
| 500 500 3 | 209 | ms | 191 | ms |
| 800 800 3 | 532 | ms | 450 | md |

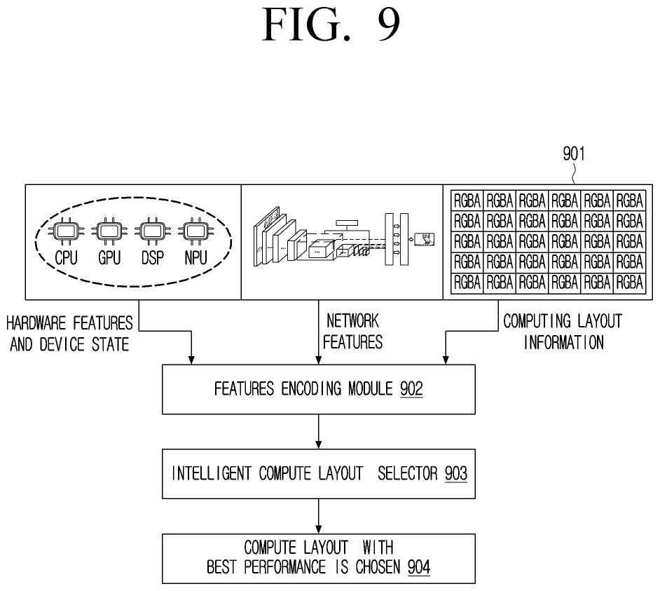

FIG. 9 is a diagram, illustrating an example pipeline architecture for selection of the computing layout, according to various embodiments.

As illustrated in FIG. 9, the pipeline architecture comprises an offline features extraction block (901), an offline features encoding block (902) and a runtime intelligent compute unit selector (903).

In the offline feature extraction block (901), features from the AI model are extracted for the DNN model and the electronic device (100). In an embodiment, the features are for example but not limited to the network (DNN model), a hardware of the electronic device (100) and the different computing layouts, etc. The features are extracted in the offline mode before runtime of the computing unit.

The offline feature encoding block (902) encodes the extracted features by a predefined schema. The encoding of the features is also performed in offline mode and hence no extra overhead is added during runtime.

The runtime intelligent compute unit selector (903) feeds the encoded features to a CNN classifier such as SqueezeNet which provides the best computing layout for the given NN. This operation is performed at runtime at 904.

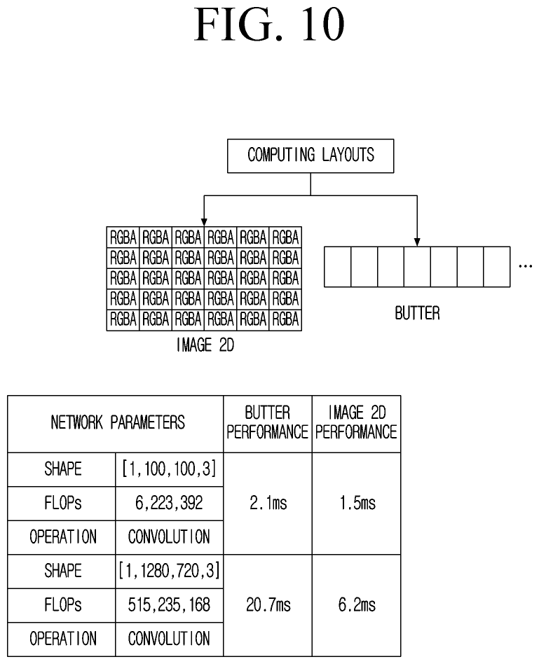

FIG. 10 is a diagram, illustrating an example dynamic computing layout of the DNN inference, according to various embodiments.

Referring to FIG. 10, for GPU the method may have two kinds of memory layouts (computing layouts) Buffer and Image 2D units in the example.

Buffer computing layout: Buffer objects are basically one-dimensional arrays which can store any data you want. Accessing logic can introduce overhead.

Image computing layout: Image can be 1d, 2d, 3d, 2d for example. 4 channel values of the data are stored in one pixel. The image computing layout uses texture pipeline available in the hardware (e. g., Mali G77 and Adreno GPUs) for input.

Accessing logic involves less overhead as compared to buffer. Performance comparison based upon network parameter and hardware on different computing layouts are as follows To show that network parameters affect performance, it is important to keep account of these parameters as well while selecting computing layout. A simple 3×3 convolution is considered with 12 output channels and strides as 1 with different input size to it to understand impact of all the parameters on inference timings.

When input shape to convolution is [1, 100, 100, 3] performance of buffer computing layout is almost same as Image compute layout due to following reasons: Accessing is buffer computing layout is not having overhead as input size is small. Texture pipeline utilization in Image2d computing layout is minimal that's why not much of performance improvements.

When Input shape to convolution is [1, 1280, 720, 3] performance of Image is almost 3.3 times better than buffer. Because of big input size accessing in buffer is slow as compared to Image. Due to big input size overall texture pipeline utilization is better. Image access is cached and optimized by means of sampler and it allows using memory properly. 92× FLOPs which may refer, for example, to frequent data accessing and fetching is required and more multiply and accumulate operations.

Above example illustrates that performance may not be consistent as it depend upon network parameters, hardware etc. Further, the proposed method reduced memory usage during inference time as computing layout switching is very less.

Currently use-cases owners have to experiment with different available computing layouts to get the best performance in terms of inference timings and memory usage. Further, the disclosure saves manual efforts and time for selecting best performing computing layout.

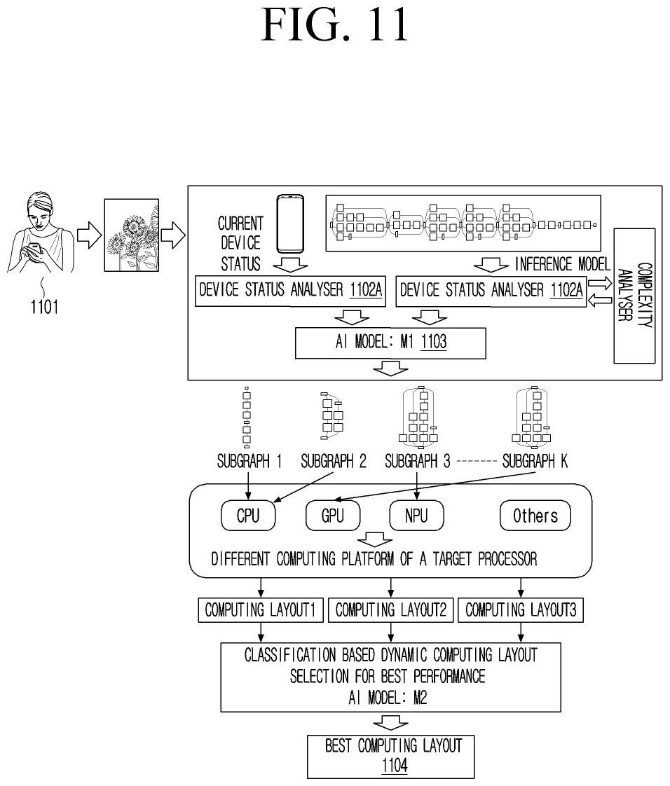

FIG. 11 is a diagram, illustrating example flow for selection of computing layout, according to various embodiments.

At 1101, a user clicks image in Night Mode camera. The DNN model loads in the background for processing. At 1102 the current device state and complexity of the ops in the model and forms subgraphs and assigns compute unit that provides best inference. At 1103, the DNN model is split into the number of sub-subgraphs. Further, at 1104, the computing unit for each sub graph is decided.

Once compute unit is set, the backend selection is decided further on available devices status eg GPU load, DNN model flops and processing unit MACC etc. For example same night mode will run on GPU texture when high loaded scenarios, however night mode processing will be pushed to buffer if the resolution of picture is less.

While the disclosure has been illustrated and described with reference to various example embodiments, it will be understood that the various example embodiments are intended to be illustrative, not limiting. It will be further understood by those skilled in the art that those skilled in the art can, by applying current knowledge, readily modify and/or adapt for various applications such specific embodiments without departing from the true spirit and full scope of the disclosure, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of various example embodiments, those skilled in the art will recognize that the embodiments herein can be practiced with modification within the spirit and scope of the embodiments as described herein. It will also be understood that any of the embodiment(s) described herein may be used in conjunction with any other embodiment(s) described herein.

What is claimed is:

1. A method of selecting a computing layout for a processor in an electronic device, the method comprising:
receiving, by the electronic device\, a Deep Neural Network (DNN) model to be executed, wherein the DNN model is associated with a task;
dividing, by the electronic device, the DNN model into a plurality of sub-graphs, wherein each sub-graph is configured to be processed individually;
identifying, by the electronic device, a computing unit from a plurality of computing units for execution of each sub-graph based on a complexity score; and
determining, by the electronic device, a computing layout from a plurality of computing layouts for each identified computing unit, wherein the sub-graph is executed on the identified computing unit through the determined computing layout.

2. The method as claimed in claim 1, wherein the electronic device comprises different on-device Artificial Intelligence (AI) models for execution of the sub-graphs and selection of the computing unit and the computing layout, and wherein the on-device AI model is personalized based on a type of the electronic device and a plurality of device conditions.

3. The method as claimed in claim 1, wherein identifying the computing unit from the plurality of computing units for execution of each sub-graph comprises:
determining, by the electronic device a complexity score for executing each sub-graph;
measuring, by the electronic device, an ongoing processing load in the plurality of computing units to determine the availability of each computing unit;
identifying, by the electronic device, a first computing unit from the plurality of computing units relevant to execution of a first sub-graph from the plurality of sub-graphs; and
performing, by the electronic device, at least one of:
selecting a second computing unit from the plurality of computing units for processing the first sub-graph, in response to determining that the ongoing processing load on the first computing unit indicates unavailability of the first computing unit, and
selecting the first computing unit for processing the first sub-graph, in response to determining that the ongoing processing load on the first computing unit indicates availability of the first computing unit.

4. The method as claimed in claim 3, wherein the first computing unit is identified based on a thermal condition of the plurality of computing units.

5. The method as claimed in claim 3, wherein the complexity score is based on a plurality of parameters associated with the sub-graph and the DNN model, wherein the plurality of parameters associated with the sub-graph comprises an input and output tensor sizes in the sub-graph, a parallelizability of an operation of the DNN model, a complexity of the DNN model, a latency of moving data between the plurality of computing units.

6. The method as claimed in claim 1, wherein determining, by the electronic device, the computing layout from the plurality of computing layouts for each identified computing unit comprises:
obtaining, by the electronic device, a plurality of network parameters associated with the DNN model, a plurality of hardware parameters of the electronic device and a plurality of parameters associated with the computing unit for which the computing layout is to be determined;
encoding, by the electronic device, the plurality of network parameters, the plurality of hardware parameters and the plurality of parameters associated with the computing unit in an offline mode;
sending, by the electronic device, the encoded parameters to a AI model for selecting the computing layout, in an online mode; and
receiving, by the electronic device, the selected computing layout for the corresponding computing unit.

7. The method as claimed in claim 6, wherein the online mode indicates execution of the DNN Model and the offline mode indicates DNN model loading period.

8. The method as claimed in claim 1 further comprises, determining dependency information of sub-graphs with each other to form independent sub-graphs.

9. The method as claimed in claim 1 further comprising, determining, by the electronic device, whether to run a sub-graph in parallel to other sub-graphs based on a dependency information of the plurality of sub-graphs, the complexity score and the availability information of the computing units.

10. An electronic device configured to select a computing layout for a processor, the electronic device comprising:
a memory; and
a processor configured to:
receive a Deep Neural Network (DNN) model to be executed, wherein the DNN model is associated with a task;
divide the DNN model into a plurality of sub-graphs, wherein each sub-graph is configured to be processed individually;
identify a computing unit from a plurality of computing units for execution of each sub-graph based on a complexity score; and
determine a computing layout from a plurality of computing layouts for each identified computing unit, wherein the sub-graph is executed on the identified computing unit through the determined computing layout.

11. The electronic device as claimed in claim 10, wherein the electronic device comprises different on-device Artificial Intelligence (AI) models for execution of the sub-graphs and selection of the computing unit and the computing layout, and wherein the on-device AI model is personalized based on a type of the electronic device and a plurality of device conditions.

12. The electronic device as claimed in claim 10, wherein the identifying the computing unit from the plurality of computing units for execution of each sub-graph comprises:
determining a complexity score for executing each sub-graph;
measuring, an ongoing processing load in the plurality of computing units to determine the availability of each computing unit;
identifying a first computing unit from the plurality of computing units relevant to execution of a first sub-graph from the plurality of sub-graphs; and
performing at least one of:
selecting a second computing unit from the plurality of computing units for processing the first sub-graph, in response to determining that the ongoing processing load on the first computing unit indicates unavailability of the first computing unit, and
selecting the first computing unit for processing the first sub-graph, in response to determining that the ongoing processing load on the first computing unit indicates availability of the first computing unit.

13. The electronic device as claimed in claim 12, wherein the processor is configured to identify the first computing unit based on a thermal condition of the plurality of computing units.

14. The electronic device as claimed in claim 12, wherein the complexity score is based on a plurality of parameters associated with the sub-graph and the DNN model, wherein the plurality of parameters associated with the sub-graph comprises an input and output tensor sizes in the sub-graph, a parallelizability of an operation of the DNN model, a complexity of the DNN model, a latency of moving data between the plurality of computing units.

15. The electronic device as claimed in claim 10, wherein the determining, by the electronic device, the computing layout from the plurality of computing layouts for each identified computing unit comprises:
obtaining a plurality of network parameters associated with the DNN model, a plurality of hardware parameters of the electronic device and a plurality of parameters associated with the computing unit for which the computing layout is to be determined;
encoding the plurality of network parameters, the plurality of hardware parameters and the plurality of parameters associated with the computing unit in an offline mode;
sending the encoded parameters to a AI model for selecting the computing layout, in an online mode; and
receiving the selected computing layout for the corresponding computing unit.
